(19) United States
(12) Patent Application Publication
(10) Pub. No.: US 2010/0217594 A1
(43) Pub. Date: Aug. 26, 2010

(54) PERSONAL AUTHENTICATION SYSTEM

(75) Inventors: Yuki SAWADA, Tokyo (JP); Kazuhiro Watada, Tokyo (JP); Kota Yasunaga, Kanagawa (JP); Hiroyuki Sakate, Kanagawa (JP)

Correspondence Address: McDERMOTT WILL & EMERY LLP, 600 13th Street, N.W., Washington, DC, 20005-3096, US

(73) Assignee: PANASONIC CORPORATION, Osaka (JP)

(21) Appl. No.: 12/776,022

(22) Filed: May 7, 2010

Related U.S. Application Data
(63) Continuation of application No. PCT/JP2008/002424, filed on Sep. 3, 2008.

(30) Foreign Application Priority Data
Dec. 17, 2007 (JP) P2007-324513

(51) Int. Cl. G10L 17/00

(52) U.S. Cl. 704/246; 704/E17.004

(57) ABSTRACT

In a system in which a business organization authenticates a user by speaker recognition, there is provided the system that obviates a necessity for the user to register a speaker model by uttering voice for each business partner. A user device 20 has voice input unit 24, speaker model preparation unit 21, storage unit 22, and communication unit 23 that transfers a speaker model. A business-organization-side management device 40 has speaker model acquisition unit 41, storage unit 42, and communication unit 43. A business-organization-side speaker recognition device 50 has speaker model acquisition unit 51; speaker model registration unit 52, characteristic acquisition unit 53, and speaker recognition unit 54. The user prepares and retains a speaker model used for speaker recognition by use of the user device 20. When registering the user as a business partner, the business organization acquires a speaker model from the user along with personal information required for transaction by use of the management device 40. The speaker recognition device 50 registers the speaker model.

### TECHNICAL FIELD

The present invention relates to a system that performs personal authentication of a user by use of speaker recognition.

### BACKGROUND ART

Personal authentication has been performed to ensure trading securities when a commodity is purchased on the Internet. For instance, during mail order sales utilizing the Internet (Internet shopping), an ID, a personal identification number, and the like, required to authenticate a user, as well as details of an order, are input.

However, an ID and a personal identification number must be accurately input, which sometimes compels the user to perform complicate operation. Further, the user must pay a close attention to keeping the ID and the personal identification number secret from third parties on his/her own authority. To this end, a proposed personal authentication method enables acceptance of an order for a commodity, or the like, without letting a user perform operations required to perform personal authentication, such as entry of an ID and a personal identification number (see; for instance, Patent Document 1).

The order acceptance method described in connection with Patent Document 1 is to save labor of inputting information required for personal authentication, such as an ID and a personal identification number, by letting a user make a speech at the time of first registration of personal data, registering characteristic information extracted from user's voice as a speaker model, and comparing the characteristic information extracted from voice made at the time of acceptance of an order with the registered speaker model from the next session or subsequent sessions, thereby identifying the speaker (speaker recognition).

The technique obviates a necessity for use of an ID and a personal identification number that are required to be strictly managed at the time of performance of personal authentication, by performance of personal authentication using the speaker recognition technique.

Patent Document 1: JP-A-2002-279245

### DISCLOSURE OF THE INVENTION

### Problem that the Invention is to Solve

However, in the case of a business management system of a business organization that provides mail order sales, the related-art personal authentication method using the foregoing speaker recognition technique requires the user to beforehand provide a speech a plurality of number of times in order to create a speaker model of the user. When the user increases the number of business organizations with which the user desires to carry out transactions, the user is required to register a speaker model based on a speech each time the number of business organizations is increased.

From a security aspect, an attention has been paid solely to personal authentication at the time of purchase of a commodity. Much attention has not been paid to security for delivery of a commodity.

The present invention aims at providing a personal authentication system using speaker recognition that obviates a necessity for registering a speaker model based on a speech for each business organization that is to be a business partner, in consideration of the aforementioned circumstance. The present invention also aims at providing a system that enhances security for the time of delivery of a commodity as well as security for the time of purchase of the commodity.

### Means for Solving the Problem

A personal authentication system comprises a user device that prepares a speaker model from a voice input by a user; a business-organization-side management device for acquiring the speaker model of the user transmitted from the user device; and a speaker recognition device that previously registers the speaker model transmitted from the business-organization-side management device and that recognizes a speaker by comparing the registered speaker model with characteristic information extracted from a voice input by the user, thereby performing personal authentication.

By the configuration, the user keeps at hand one speaker model used for speaker recognition. There is no necessity for registering voice information based on voice uttered each time the number of business partners increases. The chance of occurrence of an error, which would otherwise arise during personal authentication, can be lessened by preparing a high-precision speaker model. Voice information is independent of an ambient noise environment achieved at the time of registration, and a high precision of a speaker model to be registered is maintained, so that accuracy of personal authentication can be enhanced. According to the configuration, a speaker recognition technique can be used for personal authentication at the time of delivery of a commodity, so that enhancement of security for the time of delivery of a commodity can be accomplished.

According to a user device of the present invention, a user device included in the personal authentication system of the present invention, comprises an input unit configured to input a voice uttered by a user; a speaker model preparation unit configured to prepare a speaker model used for recognizing a speaker from voice information input by the input unit; a storage unit configured to store the speaker model prepared by the speaker model preparation unit; and a communication unit configured to transmit the speaker model stored in the storage unit to the business-organization-side management device.

The user device of the present invention has a characteristic extraction unit configured to extract a characteristic from the voice input by the input unit, wherein the communication unit transits a result of extraction performed by the characteristic extraction unit to the business-organization-side management device.

According to the configuration, when voice is input from the user device during authentication, deterioration of quality of voice, which would otherwise be caused by communication, can be lessened when compared with a case where the input voice is sent directly to the speaker recognition device. Further, the chance of occurrence of an error, which would otherwise be caused during authentication, can be diminished.

A business-organization-side management device of the present invention is a business-organization-side management device included in the personal authentication system of the present invention comprising an acquisition unit configured to acquire a speaker model transmitted from the user device; a storage configured to store the speaker model acquired by the acquisition unit; and a communication unit configured to transmit the speaker model stored in the storage unit to the speaker recognition device.

The business-organization-side management device of the present invention has a control unit configured to perform control operation so as to transmit the speaker model stored in the storage unit to the speaker recognition device according to a preset condition, wherein the communication unit transmits the speaker model according to a command from the control unit.

According to the configuration, so long as the speaker recognition device is implemented on a portable terminal device carried by a deliveryman, the business-organization-side management device automatically transfers a speaker model to the portable terminal device according to present conditions. When the speaker model is transferred at required timing or when a plurality of portable terminal devices are used, only a required speaker model can be transferred. For instance, it becomes possible to perform control operation so as to send the speaker model to the speaker recognition device a day before a delivery date, so that the business partner can save efforts for sending a speaker model each time.

According to a speaker recognition device of the present invention, a speaker recognition device included in the personal authentication system comprises a speaker model acquisition unit configured to acquire a speaker model transmitted from the business-organization-side management device; a registration unit configured to register the speaker model acquired by the acquisition unit; a characteristic acquisition unit configured to acquire a result of extraction of a characteristic from a voice uttered by a user; and a speaker recognition unit configured to ascertain a speaker by a comparison of the speaker model registered by the registration unit with the result of extraction of a characteristic acquired by the characteristic acquisition unit, thereby authenticating a person.

A speaker recognition device of the present invention further has an input unit configured to input a voice uttered by a user; and characteristic extraction unit configured to extract a characteristic from the voice input by the input unit, wherein the speaker recognition unit recognizes a speaker according to a result of comparison between the speaker model registered by the registration unit and the result of extraction of the characteristic performed by the characteristic extraction unit.

According to an integrated circuit of the present invention, an integrated circuit implemented in a user device included in the personal authentication system of the present invention comprises an input unit configured to input voice uttered by a user; a speaker model preparation unit configured to prepare a speaker model used for recognizing a speaker from voice information input by the input unit; a storage unit configured to store the speaker model prepared by the speaker model preparation unit; and a communication unit configured to transmit the speaker model stored in the storage unit to the business-organization-side management device.

According to an integrated circuit of the present invention, an integrated circuit implemented in a business-organization-size management device included in the personal authentication system of the present invention comprises an acquisition unit configured to acquire a speaker model transmitted from the user device; a storage configured to store the speaker model acquired by the acquisition unit; and a communication unit configured to transmit the speaker model stored in the storage unit to the speaker recognition device.

According to an integrated circuit of the present invention, an integrated circuit implemented in a speaker recognition device included in the personal authentication system of the present invention comprises a speaker model acquisition unit configured to acquire a speaker model transmitted from the business-organization-side management device; a registration unit configured to register the speaker model acquired by the acquisition unit; a characteristic acquisition unit that acquires a result of extraction of a characteristic from a voice uttered by a user; and a speaker recognition unit configured to ascertain a speaker by means of a comparison of the speaker model registered by the registration unit with the result of extraction of a characteristic acquired by the characteristic acquisition unit, thereby authenticating a person.

Further, according to a personal authentication method of the present invention, a personal authentication method for use in a personal authentication system comprises a user device that prepares a speaker model from a voice input by a user; a business-organization-side management device for acquiring the speaker model of the user transmitted from the user device; and a speaker recognition device that previously registers the speaker model transmitted from the business-organization-side management device and that recognizes a speaker by comparing the registered speaker model with a result of extraction of a characteristic from a voice uttered by the user, wherein the user device accepts the voice input by the user, prepares the speaker model from the voice input, and transmits the prepared speaker model to the business-organization-side device; the business-organization-side device acquires the speaker model transmitted from the user device and transmits the acquired speaker model to the speaker recognition device; and the speaker recognition device acquires the speaker model transmitted from the business-organization-side device, registers the acquired speaker model, acquires a result of extraction of a characteristic from the voice uttered by the user, and recognizes a speaker by means of a comparison of the registered speaker model with the acquired result of extraction of the characteristic, thereby authenticating a person from the result of recognition.

### Advantage of the Invention

The speaker recognition system of the present invention obviates a necessity for registering voice information based on voice uttered each time the number of a business organizations is increased, by keeping at hand one speaker model to be used for speaker recognition. Further, so long as a high-precision speaker model is prepared beforehand, a chance of occurrence of a failure during personal authentication can be lessened.

Since the speaker recognition system of the present invention enables personal authentication of a user at the time of delivery of a commodity by means of speaker recognition, security for the time of delivery of a commodity to which much attention has not hitherto been paid can be enhanced.

### BRIEF DESCRIPTION OF THE DRAWINGS

FIG. 1 is a view showing a configuration of a personal authentication system of an embodiment of the present invention.

FIG. 2 is a flowchart for describing a method for processing personal authentication of the embodiment of the present invention.

FIG. 3 is a view for describing example operation of the personal authentication system of the embodiment of the present invention.

FIG. 4 is a view showing an example of the personal authentication system of the present invention in which a user unit is configured on a portable terminal device.

FIG. 5 is a view showing an example of the personal authentication system of the present invention in which function of a speaker recognition device is configured on a portable terminal device carried by a commodity deliveryman.

FIG. 6 is a view showing an example of the personal authentication system of the present invention configured with an addition of the portable terminal device carried by the commodity deliveryman.

FIG. 7 is a view showing an example configuration in which principal functions of respective devices of the personal authentication system of the present invention are implemented in the form of an LSI.

### DESCRIPTIONS OF THE REFERENCE NUMERALS AND SYMBOLS

1 PERSONAL AUTHENTICATION SYSTEM

3 SPEAKER MODEL

20 USER DEVICE

21 SPEAKER MODEL PREPARATION UNIT IN USER DEVICE

22 STORAGE UNIT IN USER DEVICE

23 COMMUNICATIONS UNIT IN USER DEVICE

24 VOICE INPUT UNIT IN USER DEVICE

25 LSI INTO WHICH MAIN FUNCTIONS OF USER DEVICE ARE INTEGRATED

40 BUSINESS-ORGANIZATION-SIDE MANAGEMENT DEVICE

41 ACQUISITION UNIT IN MANAGEMENT DEVICE

42 STORAGE UNIT IN MANAGEMENT DEVICE

43 COMMUNICATION UNIT IN MANAGEMENT DEVICE

44 LSI INCLUDING INTEGRATED MAIN FUNCTIONS OF BUSINESS-ORGANIZATION-SIDE MANAGEMENT DEVICE

50 SPEAKER RECOGNITION DEVICE

51 ACQUISITION UNIT IN SPEAKER RECOGNITION DEVICE

52 REGISTRATION UNIT IN SPEAKER RECOGNITION DEVICE

53 CHARACTERISTIC ACQUISITION UNIT IN SPEAKER RECOGNITION DEVICE

54 SPEAKER RECOGNITION UNIT IN SPEAKER RECOGNITION DEVICE

55 LSI HAVING INTEGRATED FUNCTIONS OF SPEAKER RECOGNITION DEVICE

61 MANAGEMENT DEVICE OF BUSINESS ORGANIZATION 1

62 SPEAKER RECOGNITION DEVICE OF BUSINESS ORGANIZATION 1

63 MANAGEMENT DEVICE OF BUSINESS ORGANIZATION 2

64 SPEAKER RECOGNITION DEVICE OF BUSINESS ORGANIZATION 2

71 PORTABLE TERMINAL DEVICE MAKING UP USER DEVICE

72 BUSINESS-ORGANIZATION-SIDE MANAGEMENT DEVICE

80 BUSINESS-ORGANIZATION-SIDE PORTABLE TERMINAL DEVICE HAVING FUNCTIONS OF SPEAKER RECOGNITION DEVICE

90 BUSINESS-ORGANIZATION-SIDE PORTABLE TERMINAL DEVICE NOT HAVING FUNCTIONS OF SPEAKER RECOGNITION DEVICE

S1 VOICE INPUT STEP

S2 SPEAKER MODEL PREPARATION STEP

S3 SPEAKER MODEL TRANSFER STEP

S11 SPEAKER MODEL ACQUISITION STEP

S12 SPEAKER MODEL TRANSFER STEP

S21 SPEAKER MODEL ACQUISITION STEP

S22 SPEAKER MODEL REGISTRATION STEP

S23 CHARACTERISTIC ACQUISITION STEP

S24 SPEAKER RECOGNITION STEP

### BEST MODE FOR IMPLEMENTING THE INVENTION

An embodiment of the present invention is below-described in detail by reference to the drawings. The embodiment shows one mode of the present invention and can arbitrarily be changed within the scope of technical idea of the present invention.

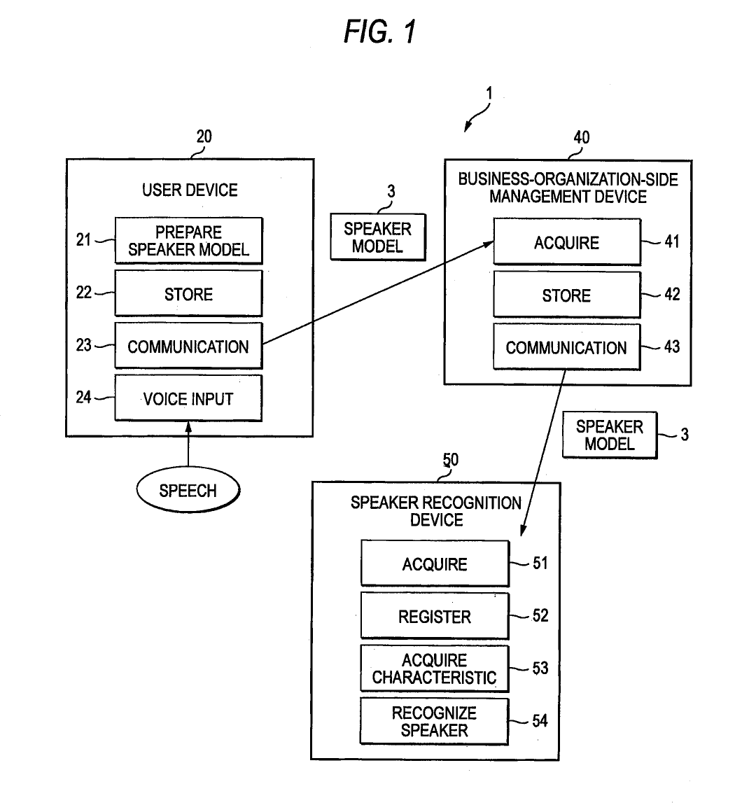

FIG. 1 is a view showing the configuration of the personal authentication system of the embodiment of the present invention. In FIG. 1, a personal authentication system 1 includes a user device 20, a business-organization-side management device 40, and a speaker recognition device 50. A speaker model 3 is exchanged among the devices.

The user device 20 is made up of a personal computer and has voice input unit 24 configured to input a voice uttered by a user; speaker model preparation unit 21 for preparing a speaker model for speaker recognition from the input voice information; storage unit 22 for storing the prepared speaker model; and communications unit 23 for transmitting the stored speaker model to a business organization.

The speaker model is prepared from characteristic information extracted from input voice as personal voice information in a predetermined transferrable format. The speaker model is transferred, as the speaker model 3 used in speaker recognition to perform personal authentication, to the business-organization-side management device 40 when personal information is registered as a user for a business organization with which the user carries out business transaction.

The business-organization-side management device 40 is a general computer system built from a server computer, a personal computer, and the like. The management device 40 has acquisition unit 41 for acquiring the speaker model 3 transmitted from the user device 20, storage unit 42 for storing the acquired speaker model 3, and communication unit 43 for transmitting the stored speaker model 3 to the speaker recognition device 50.

The business-organization-side speaker recognition device 50 can be built by use of a server computer, a personal computer, and the like. The business-organization-side speaker recognition device 50 has acquisition unit 51 for acquiring the speaker model 3 transmitted from the management device 40, speaker model registration unit 52 that registers the acquired speaker model 3, characteristic acquisition unit 53 that acquires a result of extraction of a characteristic from a voice uttered by the user, and speaker recognition unit 54 that compares the characteristic extraction result acquired by the characteristic acquisition unit 53 with the registered speaker model, thereby performing speaker recognition.

It is preferable that the personal authentication system shown in FIG. 1 performs a voice input pertaining to transaction information. In that case, the system is configured so as to have a voice recognition device targeted for un-illustrated, unspecified speakers. Using voice recognition for inputting transaction information is a commonly-known technique as described in connection with Patent Document 1.

Although descriptions are provided for an example configuration in which the business-organization-side system is made up of the management device 40, the speaker recognition device 50, and the voice recognition device, a function of the speaker recognition device 50 and a function of the voice recognition device may also be configured so as to be incorporated in the management device 40. A high-performance server computer, or the like, is used for the voice recognition device targeted for unspecified speakers and also include many commonalities, such as a voice input. Therefore, the function of the speaker recognition device can also be implemented on a computer for use as the voice recognition device.

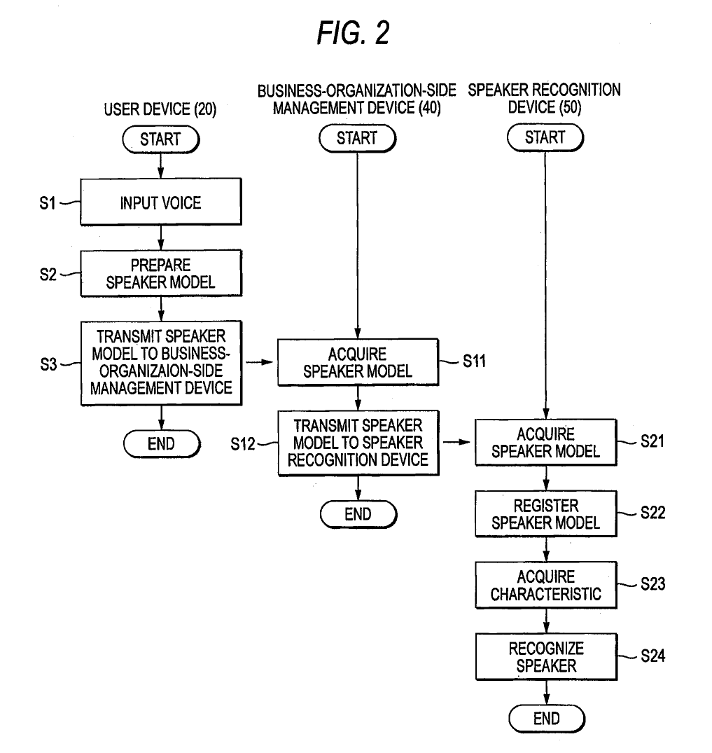

FIG. 2 is a flowchart for explaining the method for processing personal authentication in each of the user device 20, the business-organization-side management device 40, and the speaker recognition device 50 of the embodiment.

The user device 20 first inputs the voice uttered by the user by way of the voice input unit 24 in a voice input step S1. In a speaker model preparation step S2, the speaker model preparation unit 21 next prepares the speaker model 3 for speaker cognition purpose from the characteristic information extracted from the input voice. In a speaker model transfer step S3, the thus-prepared speaker model is transferred to a system of the business partner according to communication with the system of the business organization.

In a speaker model acquisition step S11, the business-organization-size management device 40 acquires the transferred speaker model. In a speaker model transfer step S12, the thus-acquired speaker model is transferred to the speaker recognition device 50. In a speaker model acquisition step S21, the speaker recognition device 50 acquires the transferred speaker model. In a speaker model registration step S22, the acquired speaker model is registered.

Subsequently, when a transaction using a phone or another unit is initiated, a result of extraction of a characteristic from a voice uttered by the user is acquired in a characteristic acquisition step S23. In a speaker recognition step S24, the acquired characteristic extraction result is compared with the registered speaker model, thereby recognizing a speaker. When the user is identified from among the registered speaker models by means of speaker recognition, the speaker recognition device 50 performs personal authentication by reference to an identification result and also a determination about other acquired information, as required.

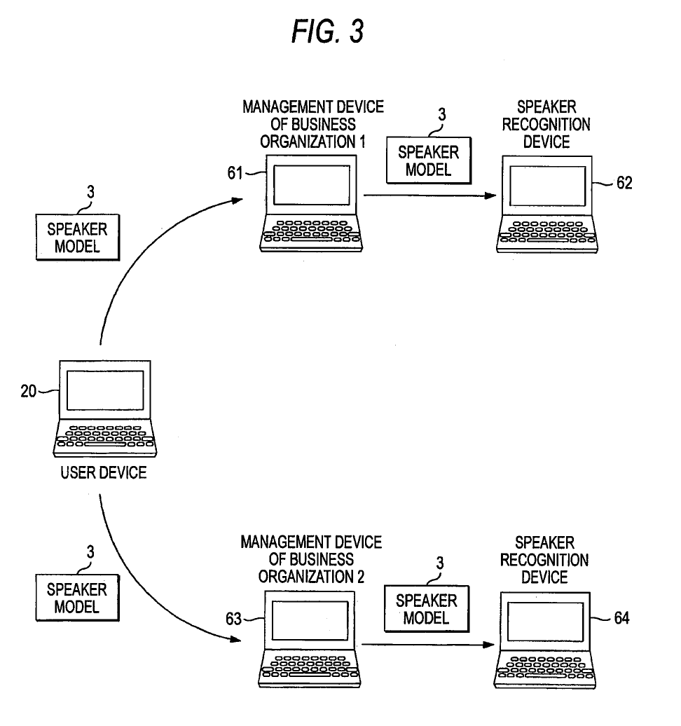

FIG. 3 is a view describing example operation of a personal authentication system of the embodiment. In FIG. 3, each of a management device 61 for a business organization 1 and a management device 63 for a business organization 2 has a function equivalent to that of the management device 40 shown in FIG. 1. Further, each of a speaker recognition device 62 and a speaker recognition device 64 has a function equivalent to that of the speaker recognition device 50.

The user first prepares the speaker model 3 by means of the user device 20 and stores the thus-prepared model in storage unit. Each time the number of business partners requiring personal authentication increases, the user transfers the speaker model 3 to the management device 61 and the management device 63 of the business organization according to a communication with a system of the business organization. The business organization transfers the thus-transferred speaker model 3 to the speaker recognition device 62 and the speaker recognition device 64, where the speaker model 3 is registered.

On the occasion of a transaction, the voice uttered by the user is transmitted to the speaker recognition device 62 or the speaker recognition device 64, whereupon the speaker recognition device 62 or the speaker recognition device 64 compares the characteristic information extracted from the voice with the registered speaker model, thereby recognizing the speaker.

According to the operating method, so long as the user keeps one speaker model to be used for speaker recognition at hand, it becomes unnecessary for the user to register voice information based on voice uttered each time the number of business partners increases. Further, so long as a high-precision speaker model is prepared, the chance of occurrence of an error, which would otherwise arise during personal authentication, can be lessened.

When there is performed registration based on voice uttered each time the number of business partners increases, voice information is dependent on an ambient noise environment achieved at the time of registration. Therefore, there is a potential risk of a low-precision speaker model being registered. On the contrary, according to the present invention, a high-precision speaker model is previously prepared, and the model is transferred to the business organization. Therefore, the accuracy of personal authentication can be enhanced.

Communication unit of the user device can also be configured so as to establish a voice communication. As a result of the user device being made able to establish voice communication, personal authentication can be performed even when the speaker model is transferred to the business organization, so that it becomes possible to ascertain that the transferred speaker model is genuine. Thus, spoofing, which would otherwise be performed by copying the speaker model, can be prevented. The user device can also extract a characteristic from an input voice at this time and transmit data pertaining to a result of extraction of a characteristic to the business-organization-side device. In this case, the business-organization-side device transmits to the speaker recognition device the data pertaining to the result of extraction of a characteristic acquired from the user device, and the speaker recognition device performs personal authentication by incorporation of the data pertaining to the result of extraction of a characteristic. On the occasion of input of a voice from the user device during authentication, deterioration of a voice through communication can thereby be prevented when compared with a case where input voice is sent directly to the speaker recognition device, so that the chance of an error arising during authentication can be lessened.

In the embodiment, the user device 20 can also be configured on a portable terminal device. As a result of the user device 20 being implemented as the portable terminal device, the personal authentication system of the present invention becomes available even in a service in which a portable terminal utilizes the Internet.

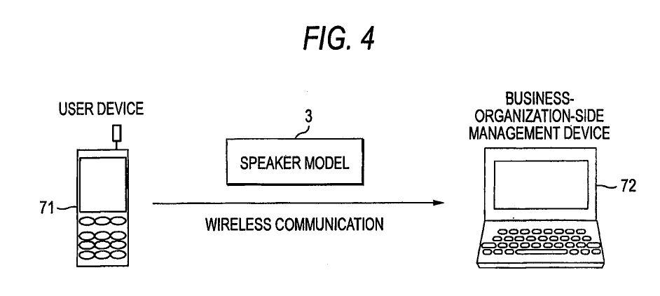

FIG. 4 is a view showing an example of the embodiment in which the user device is configured on the portable terminal device. In FIG. 4, the user device is implemented as a portable terminal device 71. The portable terminal device has voice input unit, means for preparing a speaker model, means for storing the speaker model, and communication unit for transferring the stored speaker model to a business organization through wireless communication.

A system of the business organization is identical with the configuration shown in FIG. 1 except that communication unit involving wireless communication is provided in a management device 72, and hence its explanation is omitted. The speaker recognition device is omitted from illustrations.

The user previously prepares the speaker model 3 by use of the portable terminal device 71. The user carries the portable terminal device 71 retaining the thus-prepared speaker model 3. On the occasion of initiation of a transaction with a new business organization, the user transfers the speaker model 3 to a system of the business organization according to a communication with the system of the business organization. The business organization registers the speaker model 3 transferred through wireless communication, by means of the speaker recognition device.

As mentioned above, as a result of the user device being configured on the portable terminal device, it becomes possible to carry the speaker model. Further, so long as the user device is equipped with a wireless communication function as communication unit, utilization of the speaker model is not limited to the Internet, and the user can send the speaker model to a shop from the portable terminal device by use of wireless communication when visited the shop, or the like, whereby the speaker model can be transferred without incurring a communication fee.

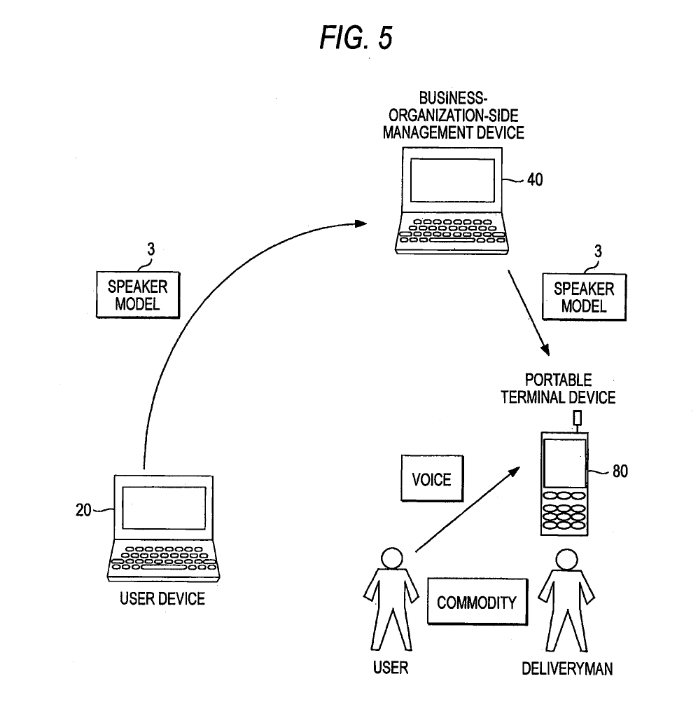

In the present embodiment, the system of the business organization can also utilize the portable terminal device. FIG. 5 is a view showing an example in which the function of the speaker recognition device is configured on a portable terminal device carried by a commodity deliveryman in the system of the business organization. In connection with the configuration of the personal authentication system shown in FIG. 1, the speaker recognition device 50 is replaced with a portable terminal device 80.

The portable terminal device 80 is equipped with, as a function, speaker model registration unit for registering a speaker model; means for inputting a voice uttered by a user and speaker recognition unit for recognizing a speaker by comparing the characteristic information extracted from the input voice with the registered speaker model.

In the configuration, the user device 20 prepares the speaker model 3, and the speaker model 3 is transferred to the system of the business partner in accordance with a communication with the system of the business organization. The speaker model is transferred from the management device 40 of the business organization to the portable terminal device 80 by wireless communication unit and registered as a user's speaker model in the portable terminal device 80.

On the occasion of a subsequent transaction, the voice uttered by the user is input to the portable terminal device 80. The characteristic information extracted from the voice is compared with the registered speaker model, to thus ascertain a speaker. Personal authentication is performed in consideration of an ascertainment result. Processing performed thus far is the same as that mentioned previously.

By means of adoption of such a configuration, personal authentication can be performed by use of speaker recognition at the time of delivery of a commodity, so that security for the time of delivery of a commodity can be enhanced.

The management device 40 of the business organization can be imparted with a function for performing control operation for automatically transferring the speaker model to the portable terminal device 80 according to the preset conditions. By means of such a function, control operation; for instance, operation for transferring the speaker model stored in the management device 40 to the portable terminal device 80 a day before delivery date, becomes possible, so that processing for transferring all speaker models to the portable terminal device 80 performed by the management device 40 can be omitted.

So long as speaker models of a family as well as a speaker model of the user are also prepared and so long as the speaker models of the family are also registered when the user registers the speaker model in the business organization, a family member as well as the user can receive a commodity at the time of delivery of a commodity.

In an example configuration of the system of the business organization shown in FIG. 5, the speaker recognition device 50 is replaced with the portable terminal device 80. However, the personal authentication system shown in FIG. 1 can also be configured so as to be additionally provided with the portable terminal device 80 having the foregoing functions rather than replacement of the speaker recognition device 50.

By means of such a configuration, personal authentication is usually performed on the occasion of a transaction through use of the speaker recognition device 50. Personal authentication can be performed at the time of delivery of a commodity through use of the portable terminal device 80. Load of the system can appropriately be distributed, and security for the time of delivery of a commodity can be enhanced.

In the example configuration, functions of the speaker recognition device are configured on the portable terminal device. The portable terminal device is not provided with a speaker recognition function and can be confined to a function of inputting a voice uttered by the user during delivery of a commodity and transferring the voice to the speaker recognition device. The portable terminal device can be made less expensive by an amount equivalent to the omitted speaker recognition function.

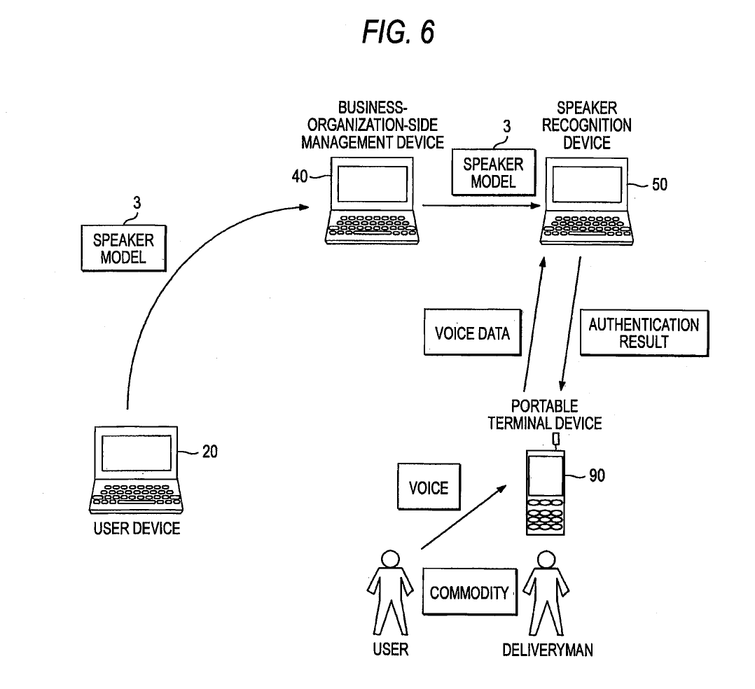

FIG. 6 is a view showing an example configuration of such a personal authentication system. The personal authentication system shown in FIG. 1 is additionally provided with a portable terminal device 90 carried by the commodity deliveryman. The portable terminal device 90 has voice input unit and communication unit that transmits an input voice to the speaker recognition device 50 and that receives a result of personal authentication.

In the configuration, the user device 20 prepares the speaker model 3. In accordance with a communication with the system of the business organization, the speaker model 3 is transferred to the system of the business partner. The speaker model is transferred from the management device 40 of the business organization to the speaker recognition device 50, and the speaker recognition device 50 registers the speaker model 3.

On the occasion of a subsequent transaction, voice uttered by the user is input to the speaker recognition device 50. Characteristic information extracted from the voice is compared with the registered speaker model, to thus ascertain a speaker, and processing for performing personal authentication in consideration of an ascertainment result performed thus far is the same as that mentioned previously.

The deliveryman of the business organization carries the portable terminal device 90, and the user makes a speech to the portable terminal device 90 at the time of delivery of a commodity. The portable terminal device 90 sends voice data to the speaker recognition device 50 by use of the communication unit and receives a result of personal authentication. By means of such a configuration, personal authentication can be performed by use of speaker recognition at the time of delivery of a commodity, so that security for the time of delivery of a commodity can be enhanced.

The portable terminal device 90 can also be configured so as to have means of extracting voice characteristic information. By adoption of such a configuration, when compared with the case where input voice is sent directly to the speaker recognition device, deterioration of quality of voice information, which would otherwise be caused by communication, is prevented, so that the potential of occurrence of an error during personal authentication can be lessened.

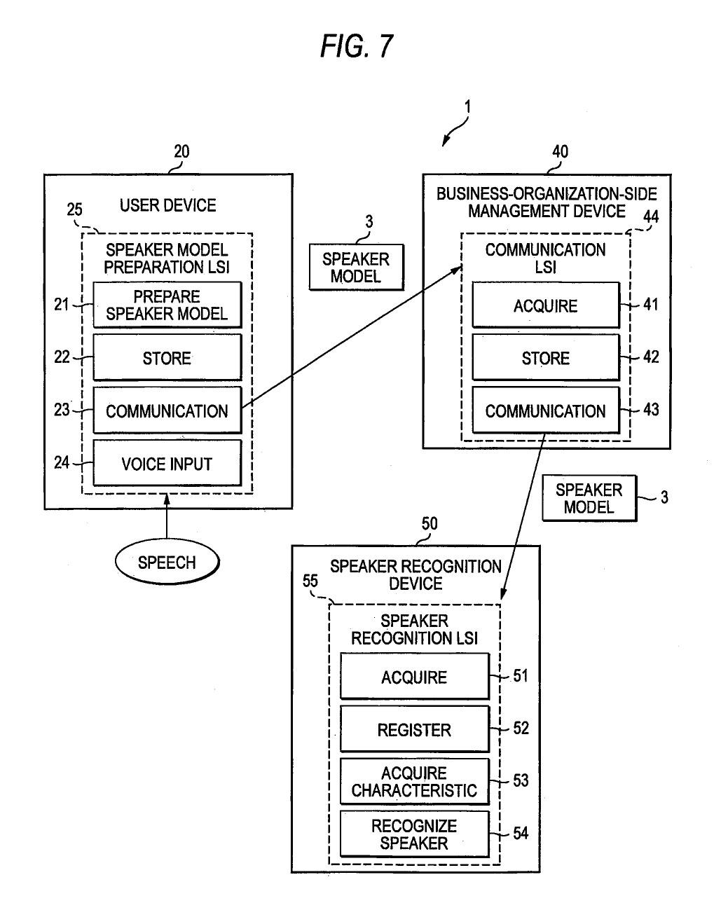

Functions of the respective device described in connection the embodiment can be configured in the form of an LSI. FIG. 7 is a view showing an example configuration in which principal functions of the respective devices shown in FIG. 1 are embodied into an LSI. In the user device 20, input unit 24 for inputting the voice uttered by the user, speaker model preparation unit 21, storage unit 22 for storing a speaker model, and communication unit 23 for transferring the speaker model to a system of the business organization are integrated into a speaker model preparation LSI 25.

In the management device 40, acquisition unit 41 for acquiring a speaker model, storage unit 42 for storing the acquired speaker model, and communication unit 43 for transferring the stored speaker model to the speaker recognition device are integrated into a communication LSI 44.

In the speaker recognition device 50, acquisition unit 51 for acquiring a speaker model, speaker model registration unit 52 for registering the thus-acquired speaker model, characteristic acquisition unit 53 for acquiring a result of extraction of a characteristic from voice uttered by a user, and speaker recognition unit 54 that compares the result of extraction of the characteristic acquired by the characteristic acquisition unit 53 with the registered speaker model, thereby recognizing a speaker, are integrated into a speaker recognition LSI 55.

As mentioned above, the principal functions of the respective devices are configured as an LSI, whereby an attempt can be made to miniaturize the system and save power.

As shown in FIG. 7, the respective functions are implemented as an LSI that is typically an integrated circuit. Each of the functions may also be individually implemented in the form of one chip, or one chip may also be implemented so as to contain some or all of the functions. The chip is herein embodied in the form of an LSI. However, the chip is often referred to as an IC, a system LSI, a super LSI, or an ultra LSI according to the degree of integration.

A technique for implementing an integrated circuit is not limited to an LSI, and the functions can also be implemented as a custom-designed circuit or a general-purpose processor. An FPGA (Field Programmable Gate Array) that is programmable after manufacture of an LSI or a reconfigurable processor that enable reconfiguration of connections and settings of a circuit cell in an LSI can also be utilized.

Moreover, if a technique for implementing an integrated circuit replaceable with an LSI appears by virtue of advancement of the semiconductor technique or another derivative technique, the functional blocks may also be integrated naturally by use of the technique. Adaptation of biotechnology is possible.

Further, another functional block, such as a wireless communication function, may also be included, or some of the functions may also be configured as another chip.

The present patent application is based on Japanese Patent Application (JP-A-2007-324513) filed on Dec. 17, 2007, the entire subject matter of which is incorporated herein by reference.

### INDUSTRIAL APPLICABILITY

The personal authentication system of the present invention is useful for personal authentication in business transaction carried out by way of the Internet and personal authentication during delivery of a commodity. An object to which a personal authentication system of the present invention is applied is not limited to the authentication operations. The personal authentication system can likewise apply to personal authentication performed when a person takes part in an event, or the like, or at the time of reservation of a hotel.

1. A personal authentication system comprising:
a user device that prepares a speaker model from a voice input by a user;
a business-organization-side management device that acquires the speaker model of the user transmitted from the user device; and
a speaker recognition device that previously registers the speaker model transmitted from the business-organization-side management device and that recognizes a speaker by comparing the registered speaker model with characteristic information extracted from a voice input by the user, thereby performing personal authentication.

2. The user device included in the personal authentication system according to claim 1, comprising:
an input unit configured to input a voice uttered by a user;
a speaker model preparation unit configured to prepare a speaker model used for recognizing a speaker from voice information input by the input unit;
a storage unit configured to store the speaker model prepared by the speaker model preparation unit; and
a communication unit configured to transmit the speaker model stored in the storage unit to the business-organization-side management device.

3. The user device according to claim 2, further comprising:
a characteristic extraction unit configured to extract a characteristic from the voice input by the input unit;
wherein the communication unit transits a result of extraction performed by the characteristic extraction unit to the business-organization-side management device.

4. A business-organization-side management device included in the personal authentication system according to claim 1, comprising:
an acquisition unit configured to acquire a speaker model transmitted from the user device;
a storage unit configured to store the speaker model acquired by the acquisition unit; and
a communication unit configured to transmit the speaker model stored in the storage unit to the speaker recognition device.

5. The business-organization-side management device according to claim 4, further comprising:
a control unit configured to perform control operation so as to transmit the speaker model stored in the storage unit to the speaker recognition device according to a preset condition, wherein
the communication unit transmits the speaker model according to a command from the control unit.

6. A speaker recognition device included in the personal authentication system according to claim 1, comprising:
a speaker model acquisition unit configured to acquire a speaker model transmitted from the business-organization-side management device;
a registration unit configured to register the speaker model acquired by the acquisition unit;
a characteristic acquisition unit configured to acquire a result of extraction of a characteristic from a voice uttered by a user; and
a speaker recognition unit configured to ascertain a speaker by a comparison of the speaker model registered by the registration unit with the result of extraction of a characteristic acquired by the characteristic acquisition unit, thereby authenticating a person.

7. The speaker recognition device according to claim 6, further comprising:
an input unit configured to input a voice uttered by a user; and
a characteristic extraction unit configured to extract a characteristic from the voice input by the input unit, wherein the speaker recognition unit recognizes a speaker according to a result of comparison between the speaker model registered by the registration unit and the result of extraction of the characteristic performed by the characteristic extraction unit.

8. An integrated circuit implemented in a user device included in the personal authentication system defined in claim 1, comprising:
an input unit configured to input a voice uttered by a user;
a speaker model preparation unit configured to prepare a speaker model used for recognizing a speaker from voice information input by the input unit;
a storage unit configured to store the speaker model prepared by the speaker model preparation unit; and
a communication unit configured to transmit the speaker model stored in the storage unit to the business-organization-side management device.

9. An integrated circuit implemented in a business-organization-size management device included in the personal authentication system defined in claim 1, comprising:
an acquisition unit configured to acquire a speaker model transmitted from the user device;
a storage unit configured to store the speaker model acquired by the acquisition unit; and
a communication unit configured to transmit the speaker model stored in the storage unit to the speaker recognition device.

10. An integrated circuit implemented in a speaker recognition device included in the personal authentication system according to claim 1, comprising:
a speaker model acquisition unit configured to acquire a speaker model transmitted from the business-organization-side management device;
a registration unit configured to register the speaker model acquired by the acquisition unit;
a characteristic acquisition unit configured to acquire a result of extraction of a characteristic from a voice uttered by a user; and
a speaker recognition unit configured to ascertains a speaker by a comparison of the speaker model registered by the registration unit with the result of extraction of a characteristic acquired by the characteristic acquisition unit, thereby authenticating a person.

11. A personal authentication method for use in a personal authentication system comprising a user device that prepares a speaker model from a voice input by a user; a business-organization-side management device for acquiring the speaker model of the user transmitted from the user device; and a speaker recognition device that previously registers the speaker model transmitted from the business-organization-side management device and that recognizes a speaker by comparing the registered speaker model with a result of extraction of a characteristic from a voice uttered by the user, wherein
the user device accepts the voice input by the user, prepares the speaker model from the voice input, and transmits the prepared speaker model to the business-organization-side device;
the business-organization-side device acquires the speaker model transmitted from the user device and transmits the acquired speaker model to the speaker recognition device; and
the speaker recognition device acquires the speaker model transmitted from the business-organization-side device, registers the acquired speaker model, acquires a result of extraction of a characteristic from the voice uttered by the user, and recognizes a speaker by a comparison of the registered speaker model with the acquired result of extraction of the characteristic, thereby authenticating a person from the result of recognition.
